(19) United States
(12) Patent Application Publication
(10) Pub. No.: US 2022/0343158 A1
(43) Pub. Date: Oct. 27, 2022

(54) METHOD, DEVICE, AND COMPUTER PROGRAM FOR CREATING TRAINING DATA IN A VEHICLE

(71) Applicant: Robert Bosch GmbH, Stuttgart (DE)

(72) Inventors: Christoph Schorn, Benningen Am Neckar (DE); Lydia Gauerhof, Sindelfingen (DE)

(21) Appl. No.: 17/658,323

(22) Filed: Apr. 7, 2022

(30) Foreign Application Priority Data
Apr. 22, 2021 (DE) 10 2021 204 040.3

(51) Int. Cl. G06N 3/08; G06K 9/62

(52) U.S. Cl. CPC G06N 3/08; G06K 9/6262; G06N 3/0454

(57) ABSTRACT

A method for detecting whether an input variable for a machine learning system is suitable as an additional training datum or test datum for the machine learning system for retraining and testing. The method includes: processing a detected input variable by way of the machine learning system, intermediate results which are ascertained during the processing of the input variable by the machine learning system being stored; processing the stored intermediate results by way of an anomaly detector, the anomaly detector outputting an output variable which characterizes whether the detected input variable associated with the intermediate results yields an anomalous behavior of the machine learning system; based on the output variable of the network, the input variable of the network and the additional input variables defined as relevant are stored/selected. A computer system, computer program, and a machine-readable memory element on which the computer program is stored are also described.

### CROSS REFERENCE

The present application claims the benefit under 35 U.S.C. § 119 of German Patent Application No. DE 10 2021 204 040.3 filed on Apr. 22, 2021, which is expressly incorporated herein by reference in its entirety.

### FIELD

The present invention relates to a method for improving a data collection for training data and also test data, which may reasonably contribute to training or retraining of a machine learning system. The present invention also relates to a device and a computer program which are each configured to carry out the method.

### BACKGROUND INFORMATION

Machine learning systems, such as neural networks (Deep Neural Networks, DNN), require a large amount of data both for their training and for their evaluation. A desired behavior, for example, a classification accuracy and robustness, is not only a function of the amount of data, but also of the variety of the data and their representativeness. However, it is difficult in many applications to describe the required data or specify the required data.

To improve the data collection, however, it is necessary to know the (missing) relevant data features and data contents—relevant data here meaning: training data which result in the required behavior of DNN (for example, performant and robust behavior of a DNN) and test data which may evaluate the required behavior.

To solve these problems, there are approaches to deliberately locate suitable data, which may reasonably supplement the amount of data.

Described in simplified terms, this has previously been achieved in that permanent data are collected, transferred to a server, and selected manually or also by machine. However, it is disadvantageous that in this procedure an enormous amount of data has to be transferred, which causes high transfer costs and which also has to be stored, which causes high memory costs. Furthermore, this procedure is contrary to data protection in many countries.

German Patent Application No. DE 10 2018 207 220 describes a method for detecting a calculation error or a malfunction of a processing unit or a memory during operation of a neural network to be supervised on the processing unit with the aid of a further neural network. The further neural network receives intermediate results of the neural network to be supervised and ascertains as a function of its intermediate results whether a calculation error or a malfunction has occurred during operation of the neural network to be supervised.

### SUMMARY

An object of the present invention is to recognize the relevant data automatically and with little computing time and only to capture these data.

The present invention achieves this object in that a small detector, in particular a small neural network, is provided which supervises a machine learning system. The detector is capable of recognizing, during operation of the machine learning system, as a function of intermediate results of the machine learning system whether data processed by the machine learning system are suitable for reasonably supplementing the amount of data.

The advantage here is that thus fewer memory/transfer resources are used. A further advantage is that the small neural network may already be operated using a very small number of parameters, therefore it may be operated in parallel to the machine learning system to be supervised without expanding the hardware.

Furthermore, the present invention may have the advantage that the detection does not take place over intervals between distributions of the data points, due to which it is possible to detect relevant data points within the distribution of the training data, which result in an incorrect statement of the machine learning system, for example, because the machine learning system has not learned to generalize via this data point. The present invention accordingly results in significantly more reliable data acquisition.

In a first aspect of the present invention, a computer-implemented method for detecting whether an input variable for a machine learning system is suitable as a relevant training data for retraining and in particular as a relevant test datum is provided with the aid of an anomaly detector. In other words, the input variable is a relevant training datum if it may provide a contribution to improving or stabilizing a required or desired performance of the machine learning system during retraining using this training datum or validating and/or verifying using the relevant test datum. The performance may be a prediction accuracy or a safety-relevant capability of the machine learning system. The machine learning system is preferably configured for computer-based vision, in particular for a classification, (object) detection, or semantic segmentation.

In accordance with an example embodiment of the present invention, the method optionally begins with the step of detecting an input variable with the aid of a sensor, in particular a sensor for detecting images. This is followed by processing of a detected input variable by the machine learning system. Intermediate results which are ascertained upon processing of the input variable by the machine learning system are saved. The processing may also be referred to as propagating. An intermediate result is understood as an intermediate result of the machine learning system which is ascertained by the machine learning system and is used further by it to ultimately ascertain an output variable of the machine learning system. If the machine learning system is a neural network, an intermediate result may be understood as an output variable of a hidden layer of the neural network.

In accordance with an example embodiment of the present invention, the anomaly detector preferably processes at least one output variable of the next-to-last layer of the neural network as an intermediate variable, since this layer has pieces of information of its preceding layers. The last layer is that layer which is not connected to any further following layer. The next-to-last layer is accordingly an immediately preceding layer, which is connected to the last layer.

Intermediate results from various layers and above all from layers of a front part of the machine learning system, also referred to as a feature extractor, surprisingly yield particularly good results for the anomaly detector.

This is followed by processing of at least one of the stored intermediate results by the anomaly detector. The anomaly detector is configured to output an output variable which characterizes whether the anomaly detector has detected an inconsistency or an anomaly of the intermediate results, also referred to hereinafter as a data anomaly. A so-called data anomaly may exist if an anomalous data point is provided with respect to the training data of the machine learning system. In other words, a data anomaly may exist if the intermediate results, which are processed by the anomaly detector, essentially are not similar or do not even correspond to intermediate variables, which have been ascertained during the training of the machine learning system on its training data set. “Essentially” may be understood to mean that the intermediate results differ from one another due to modifications, these intermediate variables generating equivalent output variables upon further propagation through the machine learning system, thus, for example, the machine learning system associating the same classification with these intermediate results or their associated input variables.

The output variable of the anomaly detector may thus characterize whether the detected input variable associated with the intermediate results was essentially contained in similar form in a training data set of the machine learning system which the anomaly detector has seen during the training of the machine learning system on its training data set using normal training data from this training data set. It may therefore be stated that the anomaly detector is designed to recognize whether the intermediate variables represent an anomaly with respect to the distribution of the training data, for example, originate from a distribution from which the training data also originate, or this distribution is defined by the training data.

Furthermore, the anomaly detector may be designed to detect a data anomaly and/or a behavior anomaly of the machine learning system. There may be a behavior anomaly if a normal data point with respect to the training data triggers an abnormal behavior of the machine learning system. A normal data point may be understood as a regular data point which occurs or would occur in this form in the training data. The abnormal behavior may be expressed in that the machine learning system does not behave in the way it was taught during the training, i.e., the way it is supposed to behave for the normal data point from the distribution with which this data point is associated. This has the advantage that data points may be found for which the machine learning system has formed an incorrect behavior, for example, has learned incorrect relationships. It is thus possible to validate whether the machine learning system has actually learned to classify objects on the basis of their shapes or classifies them incorrectly, for example, on the basis of the object color.

Subsequently, marking of the detected input variable as an additional relevant training datum or test datum follows if the anomaly detector outputs that the intermediate variable was not contained in the training data, thus that the machine learning system displays inconsistent behavior in comparison to the trained behavior. The marking may also be carried out if the ascertained output variable is greater than a predefined threshold value. The marking may take place, for example, via a flag. This marking may then be used as a trigger for a data storage of the input variable and/or a defined interval of input variables around the relevant input variable.

In accordance with an example embodiment of the present invention, it is provided that the anomaly detector is a neural network and the neural network was trained in such a way that it detects whether the detected input variable of the associated intermediate variable was contained in the training data for training the machine learning system, in particular results in a behavior of the machine learning system which is unusual. Training of a neural network is understood to mean that a cost function, which is at least a function of parameters of the neural network, is optimized by changing values of the parameters.

Furthermore, it is provided that the anomaly detector, during the processing of the intermediate variables, receives an additional variable as an input variable which is a compressed intermediate variable. The compression may be achieved, for example, by a summation of a plurality/all elements of the intermediate variable. This additional input variable based on a compression has multiple advantages. Firstly, in this way a degree of invariance against input image transformations such as rotation and zoom is achieved to represent the function activation. This is desirable since these transformations naturally take place in mobile applications and these are not to be viewed as anomalies. Secondly, the accumulation results in a comparatively low-dimensional feature activation representation. This reduces the required parameters and thus the size of the anomaly detector. Furthermore, the data transfer between the machine learning system and the anomaly detector is reduced, which is useful in particular for system architectures in which the anomaly detector is operated on separate safety supervision hardware.

Furthermore, in accordance with an example embodiment of the present invention, it is provided that the stored intermediate results are normalized. An intermediate result is preferably normalized in that a mean value is subtracted and divided by a standard deviation per obtained element of the intermediate variables. To avoid division by zero, an offset (for example 10\hat{ }-8) may be added to the standard deviation. The normalization parameters are determined during the training as a function of training data.

Furthermore, in accordance with an example embodiment of the present invention, it is provided that if the detected input variable was marked or dependent on the output variable of the anomaly detector, it is added to the training data set or test data set—depending on the intended use.

Furthermore, in accordance with an example embodiment of the present invention, it is provided that an input variable is detected as a suitable training datum according to one of the preceding examples, the machine learning system being retrained as a function of the training data set supplemented by the marked input variable. Further training may be understood to mean that already optimized parameters of the machine learning system are optimized again, in particular for the supplemented training data set.

Furthermore, in accordance with an example embodiment of the present invention, it is provided that the anomaly detector is also retrained as a function of the expanded training data, in particular the anomaly detector is retrained using the intermediate variables which the retrained machine learning system outputs upon processing of the supplemented training data.

It is to be noted that the steps for collecting the marked input variables may be repeated until a sufficient number of input variables are present and only then is the retraining carried out.

Furthermore, in accordance with an example embodiment of the present invention, it is provided that after the retraining, parameters of the machine learning system and/or the anomaly detector are transferred to a technical system, the technical system being operated as a function of the machine learning system and the technical system updating the machine learning system using the transferred parameters.

In a further aspect of the present invention, a computer-implemented method for training the anomaly detector is provided. The anomaly detector is configured here to detect whether an input variable associated with an intermediate variable is suitable for the machine learning system as a further training datum or test datum. In accordance with an example embodiment of the present invention, the method includes the following steps:

First, providing a first set of training data D_{train in} and a second set of training data D_{train out} is carried out. This may take place, for example, in that a division of provided training data into a first set of training data, which are unchanged, and into a second set, which include out-of-distribution (OOD) training data, is carried out. The training data of the second set may be produced, for example, by manipulation (e.g., Gaussian noise, salt-and-pepper, motion blur, etc.) to form OOD training data. In general, the second set contains training data which do not originate from a distribution (here: out-of-distribution), from which the training data of the first set of training data originate. A distribution is understood as an imaginary distribution which describes possible training data. If training data are drawn from the imaginary distribution, different training data are generated which are similar to one another with respect to certain properties. For example, the distribution may describe all kinds of cat images, in which greatly varying cat images are generated when drawing from the distribution. Dog images would accordingly fall in the second set, since they do not fall under the distribution for cat images.

Storing of ascertained intermediate results of the machine learning system thereupon follows, which the machine learning systems ascertained when the training data of the first set of the training data (D_{train in} were processed by the machine learning system. An assignment of the stored intermediate results to a label then follows, which characterizes that the stored intermediate results are “normal” (i.e., “in distribution data”).

These last two steps are then carried out for the second set. Ascertained further intermediate results of the machine learning system are thus stored, which the machine learning system ascertained when the training data of the second set of the training data D_{train out} were processed by the machine learning system. In addition, there is an assignment of the further stored intermediate results to a label, which characterizes that the stored intermediate variables are “not normal” (i.e., “out-of-distribution data”). Subsequently, the anomaly detector is trained in such a way that as a function of all stored intermediate results, it ascertains their assigned label.

It is provided that the first and second set of training data are essentially equal in size. Balanced training data are thus provided. It is advantageous here that the anomaly detector better learns to distinguish anomalies from non-anomalies. Furthermore, this also results in a better statement quality of the anomaly detector. “Essentially” may mean that the number of the training data of the sets differs by at most 10%, preferably by at most 5%, and particularly preferably by at most 1%.

Furthermore, in accordance with an example embodiment of the present invention, it is provided that the second set including OOD training data contains different types of OOD. Furthermore, it is provided that in addition to the intermediate results, a further variable is stored in each case, which is a compression of the particular intermediate results and the anomaly detector receives at least one of these compressed intermediate results as an additional input variable.

The machine learning system may ascertain a control variable as a function of the detected input variable. The control variable may be used to control an actuator of a technical system. The technical system may be, for example, an (at least semi-autonomous) vehicle, a robot, a tool, a machine tool, or a flying object, such as a drone.

In a further aspect of the present invention, a computer program is provided. The computer program is configured to carry out one of the above-mentioned methods. The computer program includes instructions which prompt a computer to carry out one of these mentioned methods including all of its steps when the computer program runs on the computer. Furthermore, a machine-readable memory module is provided, on which the computer program is stored. Furthermore, a device is provided which is configured to carry out one of the methods.

Exemplary embodiments of the above-mentioned aspects of the present invention are shown in the figures and explained in greater detail in the following description.

### BRIEF DESCRIPTION OF THE DRAWINGS

FIG. 1 shows a schematic representation of a vehicle, in accordance with an example embodiment of the present invention.

FIG. 2 shows a schematic representation of a first and a second neural network, in accordance with an example embodiment of the present invention.

FIG. 3 shows a schematic representation of one specific example embodiment of a method for detecting suitable further training data, in accordance with the present invention.

FIG. 4 shows a schematic representation of one specific example embodiment of a device for training the first and/or second neural network, in accordance with the present invention.

### DETAILED DESCRIPTION OF EXAMPLE EMBODIMENTS

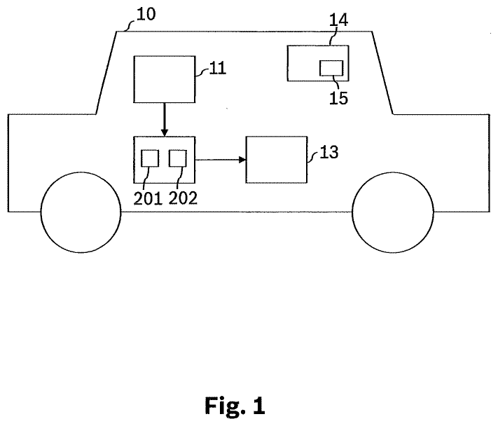

FIG. 1 shows a schematic representation of a vehicle 10. In a further exemplary embodiment, vehicle 10 may be a service, assembly, or stationary production robot, alternatively an autonomous flying object such as a drone. At least vehicle 10 may include a detection unit 11. Detection unit 11 may be, for example, a camera which detects surroundings of vehicle 10. Other types of sensors such as radar or LIDAR are also possible. Detection unit 11 may be connected to a first trained neural network 201. First trained neural network 201 ascertains an output variable as a function of a provided input variable, for example, provided by detection unit 11, and as a function of a plurality of parameters of first trained neural network 201. The output variable may be conveyed to an actuator control unit 13. Actuator control unit 13 controls an actuator as a function of the output variable of first trained neural network 201. The actuator may be a motor of vehicle 10 in this exemplary embodiment.

First trained neural network 201 is supervised with the aid of a second trained neural network 202. If, for example, an input variable of first trained neural network 201 is propagated through this neural network, which, for example, was underrepresented in the training data or was not included at all, in particular which results in an inconsistent behavior of network 201, this may be detected with the aid of second trained neural network 202. The detected malfunction may optionally be taken into consideration by actuator control unit 13 and the actuator may be activated accordingly.

Furthermore, vehicle 10 includes a processing unit 14 and a machine-readable memory element 15. A computer program may be stored on memory element 15 which includes commands which, when the commands are executed on processing unit 14, have the result that processing unit 14 carries out the method according to the present invention. It is also possible that a download product or an artificially generated signal, which may each include the computer program, after reception at a receiver of vehicle 10, prompts processing unit 14 to carry out the method according to the present invention.

In another exemplary embodiment, actuator control unit 13 includes a release system. The release system decides whether an object, for example, a detected robot or a detected person, has access to an area as a function of the output variable of first trained neural network 201. The actuator may preferably be activated as a function of a decision of the release system.

In an alternative exemplary embodiment, vehicle 10 may be a tool or a machine tool. A material of a workpiece may be classified with the aid of first trained neural network. The actuator may be, for example, a motor which drives a grinding head here.

In another specific embodiment, first trained neural network 201 is used in a measuring system (not shown in the figures). The measuring system differs from vehicle 10 as shown in FIG. 1 in that the measuring system does not include an actuator control unit 13. The measuring system may store or represent the output variable of first trained neural network 201, instead of conveying it to actuator control unit 13, for example, with the aid of visual or auditory representations.

It is also possible that in a refinement of the measuring system, detection unit 11 detects an image of a human or animal body or a part thereof. For example, this may take place with the aid of an optical signal, with the aid of an ultrasound signal, or with the aid of an MRT/CT method. The measuring system in this refinement may include first trained neural network 201, which is trained to output a classification as a function of the input variable, for example, which clinical picture possibly exists on the basis of this input variable. Second trained neural network 202 supervises first trained neural network 201 here.

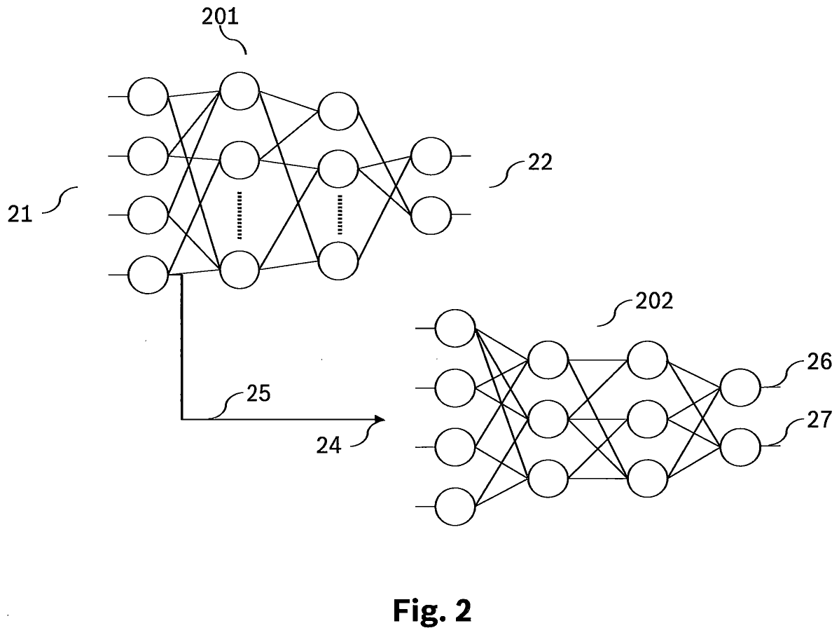

The two trained neural networks 201, 202 and their interconnection are schematically shown in FIG. 2.

First trained neural network 201 includes a plurality of layers each including multiple neurons, which are connected to neurons of preceding and following layers. The first layer of first trained neural network 201 receives an input variable 21 which is processed in a first layer of first trained neural network 201. The result of the first layer is conveyed to the following layer, which receives this result as an input variable and ascertains an output variable as a function of this result. The output variable is subsequently conveyed to the following layer. This described, processing (propagation) in layers of the input variable along first trained neural network 201 is carried out until a last layer of first trained neural network 201 has ascertained its output variable 22.

Second trained neural network 202 receives at least one output variable of at least one of the layers of first trained neural network 201 as an input variable 24, which is initially preprocessed as described at the outset and is then used as an input variable, and subsequently ascertains an output variable 26 as a function of this input variable 24. This output variable 26 preferably characterizes whether input variable 21 propagated by first neural network is an anomaly, thus whether this input variable 21 was included in the training data for training the first neural network, or was not represented or underrepresented or the like, or triggers a desired/known behavior in network 201.

Input variable 24 of second trained neural network 202 may be provided, for example, with the aid of at least one connection 25 to second trained neural network 202.

In a further exemplary embodiment, at least one output variable of one of the layers of first trained neural network 201 may include a higher-dimensional vector, whose individual elements are provided summed as an additional input variable of second trained neural network 202. It is possible to use similar information compression methods, so that input variable 24 of second trained neural network 202 is more compact.

In addition, second trained neural network 202 may ascertain a second output variable 27 as a function of a provided input variable 24. Second output variable 27 may, like output variable 22 of first trained neural network 21, characterize, in particular classify, the input variable of first trained neural network 201.

In another specific embodiment, first or second output variable 26, 27 may solely be a trigger signal which triggers, for example, a data acquisition of the processed data point. Alternatively, the data acquisition may extend over multiple processed data points. For example, it may be aborted after a defined time interval or after a defined acquisition abortion criterion, for example, to thus record a sequence of data points. The acquisition abortion criterion may be, for example, when the observed output variable of the second neural network drops below the threshold value.

In another specific embodiment, at least one output variable 26, 27 is a scalar, which may assume a value from the interval [0; 1] and characterizes a probability of an anomaly, or characterizes classes, for example, “anomaly” and “non-anomaly.” Alternatively, the output variable may distinguish between a plurality of classes, for example, whether an anomaly is present for a certain class, such as an anomaly due to different weather conditions, rare situations, or hazardous situations. The scalar may also characterize a “region of interest” in the input variable. A section of the input variable may be associated with each value of the scalar here.

Second neural network 202 may either output one of these output variables or alternatively this network may output several of these output variables or each of these output variables jointly. A second neural network 202 designed in this way may be used in general for all further specific embodiments and applications, the data acquisition being triggered when either at least one or a plurality of the output variables exceeds a predefined threshold value. The threshold values may be defined separately for the different output variables.

Input variable 24 of second neural network 202 is at least one intermediate result, also called an intermediate variable hereinafter, of first neural network 201. However, it is also possible that this input variable 24 includes up to all intermediate results. These may then be combined to form a tensor, for example. It is to be noted that the input of second neural network 202 is also be designed in accordance with the dimensions of this tensor.

If first neural network 201 has a (2D) convolution layer, which is typically used in image classification, the layer output is made up of multiple (2D) intermediate result maps (feature maps), which correspond to the various filter cores of the layer. These intermediate result maps may be added directly or in compressed form to input variable 24.

In one preferred specific embodiment, a single value is added in addition to each intermediate result map by summing over all values of the particular intermediate result map.

In one particularly preferred specific embodiment, second neural network 202 is a small, forward directed neural network which ascertains as a function of its input variable 24 whether an anomaly or non-anomaly is present.

Second neural network 202 may be replaced by other models, for example, classical/statistical methods. The main advantage results from the use of intermediate results of the most important DNN as an input and the analysis of these results with regard to their inconsistency with respect to intermediate results, which were present during the training of first neural network 201.

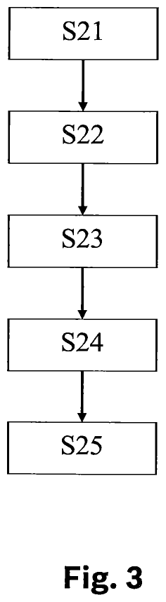

FIG. 3 shows a schematic representation of a method for detecting further relevant training data and optionally a downstream further training as a function of the detected further training data.

The method may begin with step S21. Training of second neural network 202 takes place in this step. For this purpose, it is assumed that first neural network 201 is already trained.

A standard supervised training including binary cross-entropy loss, and ADAM optimizer including standard hyperparameters may be used for the training.

Second neural network 202 may be trained for an “out-of-distribution” (OOD) recognition. For this purpose, training data are provided which include in-distribution training data from a first training data set D_{train in}, on which first neural network 201 was trained, and an out-of-distribution training data set D_{train out} All possible types of OOD data are typically not known at the time of development. Therefore, D_{train out} are to be selected in such a way that second neural network 202 learns the various OOD data in generalized form.

Training data from the two training data sets D_{train in}, D_{train out} are propagated through first neural network 201 and the intermediate results occurring are recorded and identified using a binary label, which classifies them as anomalous or non-anomalous. The binary label is assigned as a function of the training data set from which the particular training data were drawn.

It is to be noted that test data for the evaluation of the second neural network may be created similarly to the training data. Furthermore, it is to be noted that the above procedure may be applied both for learning data anomalies and for behavior anomalies by the anomaly detector, the out-of-distribution training data set containing corresponding manipulated training data, so that these induce the corresponding anomalies.

Additionally or alternatively, both neural networks 201, 202 may be trained alternately, the first neural network preferably first being trained only using training data D_{train in}.

After the training of step S21 is completed, step S22 follows. A detection of anomalies takes place herein. During operation of first neural network 201, for example, in vehicle 10, second neural network 202 receives intermediate results of first neural network 201.

An anomaly is detected by second neural network 202 if output variable 26, 27 is greater than a predefined threshold value, or if “anomaly” is output as a class.

If an anomaly was detected in step S22, in following step S23, that input variable, as a function of whose intermediate variable an anomaly was detected by the second neural network, is added to the training data and/or test data, preferably including a tag. In a subsequent, optional step, this input variable is labeled.

This input variable is then preferably transferred to a central server and added there as a further training datum to the training data for first neural network 201. These data may also be used as test data, since the data may include “corner cases.” A corner case may thus include an anomaly which results in an undesirable behavior in network 201. An intermediate step is possible in that the first collected data are evaluated in a test data set as a “corner case” and ultimately to retrain the anomaly detector once again thereon, to then deliberately collect training data during the second data acquisition. With the aid of these data, a required or desired performance of the machine learning system is to be tested or, upon retraining using this training datum, improved or stabilized. The performance may be a prediction accuracy or a safety-relevant capability of the machine learning system.

Step S24 may thereupon follow. Retraining of first neural network 201 is carried out herein as a function of the training data set which was expanded in the preceding step. Second neural network 202 is advantageously also retrained here as a function of this training data set and also as a function of newly recorded intermediate variables of the retrained first neural network.

Optionally, retrained first and/or second neural network 201, 202 may be updated in the vehicle, i.e., the changed parameters according to step S24 are transferred to the vehicle, which thereupon replaces the parameters of its neural networks with the transferred parameters.

It is possible that steps S22 and S23 are carried out multiple times in succession until sufficiently many new training data or test data are present. After ending at step S25, the method may begin again at step S22. Furthermore, it is possible that while step S24 and/or S25 is carried out, steps S22 and S23 run in parallel.

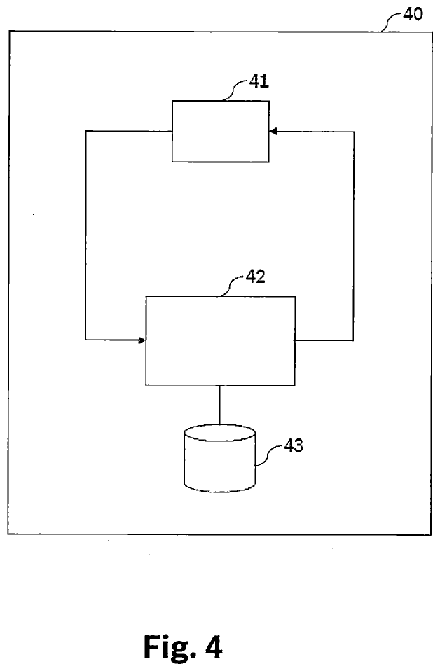

FIG. 4 shows a schematic representation of a device 40 for training neural networks 201, 202, in particular for carrying out steps S21 and/or S24. Device 40 includes a training module 41 and a module 42 to be trained. This module 42 to be trained includes the two neural networks according to FIG. 2. Device 40 for training neural networks 201, 202 trains neural networks 201, 202 as a function of output variables of neural networks 201, 202 and preferably using predefinable training data. Detection network 202 is preferably trained separately from machine learning system 201, which is already completely trained. During the training, parameters of particular machine learning system 201, 202 to be trained, which are stored in memory 43, are adapted.

What is claimed is:

1. A method for detecting whether an input variable for a machine learning system is suitable as an additional training datum for retraining or as a test datum for validating, the method comprising the following steps:
processing a detected input variable using the machine learning system, intermediate results which are ascertained during the processing of the input variable by the machine learning system being stored;
processing at least one of the stored intermediate results using an anomaly detector, the anomaly detector outputting an output variable which characterizes whether the detected input variable associated with the intermediate results is an anomalous data point with respect to training data of the machine learning system or is a normal data point with respect to the training data, which triggers an abnormal behavior of the machine learning system; and
marking the detected input variable as an additional training datum or test datum when the anomaly detector outputs that an abnormal data point or an abnormal behavior exists.

2. The method as recited in claim 1, wherein the anomaly detector is a neural network, the neural network having been trained in such a way that the neural network detects whether the input variable associated with the intermediate results is an abnormal data point, when the input variable was not contained in similar form in the training data for training the machine learning system, and/or the neural network detects whether the machine learning system provides an abnormal behavior with respect to trained behavior.

3. The method as recited in claim 1, wherein the anomaly detector receives an additional variable as an input variable during the processing of the intermediate results, which is a compressed intermediate result of one of the stored intermediate results.

4. The method as recited in claim 1, wherein the stored intermediate results are normalized.

5. The method as recited in claim 1, wherein when the detected input variable has been marked, the detected input variable is added to a training data set and a plurality of further input variables which occur immediately in time in relation to the detected input variable is stored and added to the training and test data set.

6. A method for retraining of a machine learning system, the method comprising the following steps:
detecting an input variable as a suitable training datum or test datum, including:
processing the detected input variable using the machine learning system, intermediate results which are ascertained during the processing of the input variable by the machine learning system being stored,
processing at least one of the stored intermediate results using an anomaly detector, the anomaly detector outputting an output variable which characterizes whether the detected input variable associated with the intermediate results is an anomalous data point with respect to training data of the machine learning system or is a normal data point with respect to the training data, which triggers an abnormal behavior of the machine learning system,
marking the detected input variable as an additional training datum or test datum when the anomaly detector outputs that an abnormal data point or an abnormal behavior exists; and
retraining or testing the machine learning system as a function of a training data set supplemented with the marked input variable.

7. The method as recited in claim 6, wherein the anomaly detector is also retrained as a function of the supplemented training data set.

8. The method as recited in claim 1, wherein after the retraining, parameters of the machine learning system and/or the anomaly detector are transferred to a technical system, the technical system being operated as a function of the machine learning system and the technical system updating the machine learning system using the transferred parameters.

9. A method for training an anomaly detector, comprising the following steps:
providing a first set of training data and a second set of training data, the second set of training data containing training data which trigger an inconsistent behavior of a machine learning system, which do not originate from a distribution from which the training data of the first set of the training data originate;
storing first ascertained intermediate results of the machine learning system, which the machine learning system has ascertained, as the training data of the first set of the training data which were processed by the machine learning system;
assigning the first stored intermediate results each to a label which characterizes that the stored intermediate results are “normal”;
storing second ascertained intermediate results of the machine learning system, which the machine learning system has ascertained, as the training data of the second set of the training data which were processed by the machine learning system;
assigning the second stored intermediate results each to a label which characterizes that the stored intermediate results are “not normal”; and
training the anomaly detector in such a way that it ascertains, as a function of the first and second intermediate results, their assigned label.

10. The method as recited in claim 9, wherein the first and second set of the training data are essentially of equal size.

11. The method as recited in claim 9, wherein normalization parameters are ascertained as a function of the stored first and second intermediate results, the first and second intermediate results being normalized as a function of the normalization parameters and then being used as an input variable for the anomaly detector.

12. The method as recited in claim 9, wherein the anomaly detector is used for collecting data, which are suitable for retraining and testing of a machine learning system.

13. A non-transitory machine-readable memory element on which is stored a computer program for detecting whether an input variable for a machine learning system is suitable as an additional training datum for retraining or as a test datum for validating, the computer program, when executed by a computer, causing the computer to perform the following steps:
processing a detected input variable using the machine learning system, intermediate results which are ascertained during the processing of the input variable by the machine learning system being stored;
processing at least one of the stored intermediate results using an anomaly detector, the anomaly detector outputting an output variable which characterizes whether the detected input variable associated with the intermediate results is an anomalous data point with respect to training data of the machine learning system or is a normal data point with respect to the training data, which triggers an abnormal behavior of the machine learning system; and
marking the detected input variable as an additional training datum or test datum when the anomaly detector outputs that an abnormal data point or an abnormal behavior exists.

14. A device configured to detect whether an input variable for a machine learning system is suitable as an additional training datum for retraining or as a test datum for validating, the device configured to:
process a detected input variable using the machine learning system, intermediate results which are ascertained during the processing of the input variable by the machine learning system being stored;
process at least one of the stored intermediate results using an anomaly detector, the anomaly detector outputting an output variable which characterizes whether the detected input variable associated with the intermediate results is an anomalous data point with respect to training data of the machine learning system or is a normal data point with respect to the training data, which triggers an abnormal behavior of the machine learning system; and
mark the detected input variable as an additional training datum or test datum when the anomaly detector outputs that an abnormal data point or an abnormal behavior exists.
